(19) United States
(12) Patent Application Publication
(10) Pub. No.: US 2002/0167719 A1
(43) Pub. Date: Nov. 14, 2002

(54) Method of pump wavelength combing for enhanced power dynamic range and redundancy broad band raman optical amplifier system

(76) Inventors: Bo Pedersen, Annapolis, MD (US); William Shieh, Columbia, MD (US); Vladimir Petricevic, Columbia, MD (US); Thomas Clark, Columbia, MD (US)

Correspondence Address: Johnny A. Kumar, FOLEY & LARDNER, Washington Harbour, 3000 K Street, N.W., Suite 500, Washington, DC, 20007-5109, US

(21) Appl. No.: 09/838,594

(22) Filed: Apr. 20, 2001

(51) Int. Cl. H01S 3/00

(52) U.S. Cl. 359/341.3

(57) ABSTRACT

An optical amplifier having redundancy and a dynamic range of pump power is provided. The amplifier contains a plurality of optical pump sources which are adapted to emit a plurality of pumps. The amplifier also contains a P×V coupler containing P inputs and V outputs, which is adapted to receive the pumps and to output V pump profiles, where P and V are positive integers >1 and P=V or P≠V. The pump profiles include a first set of pumps having a first set of wavelengths and having a first power and a second set of pumps having a second set of wavelengths different from the first set of wavelengths and having a second power different than the first power. The amplifier optionally contains at least one spare optical pump source which is adapted to be turned off during operation of the amplifier unless at least one of the plurality of optical pump sources becomes non operational during the operation of the amplifier.

### FIELD OF INVENTION

This invention relates generally to optical amplifiers and in particular to Raman optical amplifiers with a dynamic range of pump powers.

### BACKGROUND OF THE INVENTION

For long haul optical communications, the optical signal must be periodically amplified. Raman amplification is one amplification scheme that can provide a broad and relatively flat gain profile over the wavelength range used in optical communications (See Y. Emori, “100 nm bandwidth flat-gain Raman Amplifiers pumped and gain-equalized by 12-wavelength channel WDM Diode Unit,” Electronic Lett., Vol. 35, no 16, p. 1355 (1999) and F. Koch et. al., “Broadband gain flattened Raman Amplifiers to extend to the third telecommunication window,” OFC'2000, Paper FF3, (2000)).

Raman amplifiers may be either distributed or discrete (See High Sensitivity 1.3 μm Optically Pre-Amplified Receiver Using Raman Amplification,” Electronic Letters, vol. 32, no. 23, p. 2164 (1996)). The Raman gain material in distributed Raman amplifiers is the transmission optical fiber, while a special spooled gain fiber is typically used in discrete Raman amplifiers.

Raman amplifiers use stimulated Raman scattering to amplify an optical transmission signal, resulting in a Raman gain. In stimulated Raman scattering, radiation from a pump radiation source interacts with the optical transmission signal to increase the power of the transmission signal. The frequency of the transmission optical signal transmitted through an optical fiber, is less than the frequency of optical pump radiation. Thus, the wavelength of the pump radiation is shorter (i.e., lower) than the wavelength of the radiation of the transmission signal. One property of the Raman gain is the down shift in the gain frequency (upshift in wavelength) from the pump frequency due to the pump radiation interaction with optical phonons (vibrations) of the Raman gain material, i.e., the medium through which the pump radiation and the optical transmission signal are traversing. The largest gain occurs at about a 100 nm shift from the pump wavelength for silica fibers pumped with pump radiation having a wavelength of 1400 nm. Thus, the maximum gain for a single pump wavelength of about 1400 nm will occur at a signal wavelength of about 1500 nm.

The gain profile having typical bandwidth of 20-30 nm for a single wavelength pump is considered too narrow for some optical communications applications, such as wavelength division multiplexing (WDM), where a broad range of wavelengths must be amplified. To broaden the gain profile, Raman amplifiers employing multiple pump wavelengths over a broad wavelength range have been suggested. The individual gain profiles attributable to each pump laser overlap, which results in a combined broad gain profile.

FIG. 1 is a schematic of a typical optical communication system using Raman amplifiers for periodic amplification of the optical signal. The system includes transmitter terminal 10 and receiver terminal 11. Although signals could be directed from just the transmitter terminal 10 to the receiver terminal 11, in general the transmitter terminal 10 and receiver terminal 11 are typically transmitter/receiver terminals for bidirectional communication, as shown in FIG. 1. In this case, each of the transmitter/receiver terminals will have transmitters as well as receivers. The terminals 10 and 11 are connected by optical fibers 12 and 13 for bidirectional communication. One or more Raman amplifiers 14A, 14B, 14C, 14D, 14E, 14F are interdisposed in the path of each the fiber. Each amplifier contains a plurality of pump lasers 15-1, 15-2, . . . 15-N. For example, there may be twelve pump lasers for each amplifier (i.e., N=12) (See Y. Emori, “100 nm bandwidth flat-gain Raman Amplifiers pumped and gain-equalized by 12-wavelength channel WDM Diode Unit,” Electronic Lett., Vol. 35, no 16, p. 1355 (1999), incorporated herein by reference). Each pump laser emits radiation at a different pump wavelength, λ₁, λ₂, . . . λ_{N}. Each amplifier also contains a pump wavelength coupler 16, which combines the radiation from the pump lasers 15-1, 15-2, . . . , 15-N and directs the combined pump radiation beam to a pump-signal combiner 17, such as a wavelength division multiplexer. The pump-signal combiner 17 couples the pump radiation beam into the fibers 12 and 13 without degrading the optical transmission signal in the fibers 12, 13.

In order to obtain a relatively flat gain profile, the shorter pump wavelengths should have a higher pump power than the longer pump wavelengths. This is required due to the transfer of the pump energy from the shorter pump wavelengths (higher photon energy) to the longer pump wavelengths due to stimulated Raman scattering. Thus, to compensate for the pump-pump energy loss at shorter wavelengths, the shorter pump wavelengths should have increased power.

A typical prior art pump power-pump wavelength scheme to achieve a relatively flat and broad Raman gain profile is illustrated in FIG. 2 for the case of twelve pump wavelengths λ₁-λ₁₂. As can be seen in FIG. 2, the pump power generally decreases for increasing wavelength. In order to decrease costs, to meet system requirements and to simplify control of the amplifiers, it is desirable that all pump lasers should be identical. While the identical lasers may be operated at a somewhat different power, a wide dynamic range of pump powers (i.e., wide range of achievable laser powers) between identical, reasonably priced pump lasers cannot be achieved. For example, the laser power may be 200 mW, for the first laser 15-1 emitting the shortest wavelength, λ₁, which is 10 times the 40 mW power of the N^{th} laser, 15-N, emitting the longest wavelength, λ_{N}. However, a 20 mW power may be required, for example, for pump wavelength N. Thus, an exemplary wide dynamic range of pump powers of 200 to 20 mW may be required for the pump wavelengths. Common pump lasers used in Raman amplifiers lack such a wide dynamic range of pump powers. Therefore, in order to decrease the power of the pump lasers which emit longer pump wavelengths, an attenuator must be used. For example, an attenuator must be used to decrease the power of the N^{th} laser 15-N from 40 to 20 mW. However, the use of an attenuator is undesirable because it wastes pump laser power and increases the cost of the optical communication. Introducing an attenuator also adds additional cost and complexity to the attenuator.

Furthermore, the prior art multiple pump laser system is unreliable and lacks redundancy. In order to achieve a rather flat gain profile, all pump lasers must be operational. However, if one or more of the lasers becomes non-operational (i.e., breaks or becomes disconnected or misaligned), then the gain profile becomes non-uniform, because an individual gain profile attributable to the non-operational pump laser is removed from the combined gain profile. Therefore, it would be desirable to achieve a reliable Raman amplifier with a built-in redundancy and a wide dynamic range of pump power.

### BRIEF SUMMARY OF THE INVENTION

The present inventors have realized that the dynamic range of pump powers and the redundancy of an optical amplifier, such as a Raman optical amplifier, may be increased by adding a P×V coupler to the amplifier. A P×V coupler is defined as a coupler having P inputs and V outputs, where P and V are integers >1, and P=V or P≠V. The P×V coupler may be, for example a 2×2, a 2×3, a 4×4, etc. coupler. A particular property of the P×V coupler is that each of its V outputs delivers an identical pump profile having every wavelength provided into all of its P inputs. However, the magnitude of each radiation profile delivered by each of the V outputs has 1/V power of the combined radiation profile provided into its inputs.

The amplifier also contains at least one optical pump source that emits pump radiation having N wavelengths, where N is an integer >2. Preferably, the amplifier contains N optical pump sources, such as N semiconductor lasers, each emitting pump radiation having a particular pump wavelength and pump power. It should be noted that each laser emits a finite bandwidth of wavelengths centered around the emission or peak pump wavelength.

The dynamic range of pump powers of the amplifier containing the P×V coupler is increased when the pump profiles provided by the outputs of the P×V coupler include a first set of pumps having a first set of wavelengths and having a first power, and a second set of pumps having a second set of wavelengths different from the first set of wavelengths and having a second power different than the first power. Each set of pumps may have one pump or a plurality of pumps having adjacent wavelengths. For example, in a Raman amplifier, adjacent wavelengths may be wavelengths that are separated by 20 nm or less, preferably by 10 nm or less.

The dynamic range of the amplifier is preferably obtained when a first and a second pump (i.e., pump radiation) emitted by at least a first and a second pump source have the same or adjacent wavelengths, while a third pump emitted by at least a third pump source has a power which is less than the sum of the powers of the first and the second signals. Preferably, the third pump has a longer wavelength and a lower power than either the first or the second pumps. Most preferably, the third pump source emits a pump having a wavelength that is neither the same as nor adjacent to the wavelengths of the first and the second pumps.

Thus, for example, pumps from two pump sources having the same wavelength, λ₁ (or adjacent wavelengths) are provided into both inputs of a 2×2 coupler. Each of the two outputs of the coupler provide a pump having the wavelength λ₁ and having the same power as that emitted by each of the first two pump sources.

A pump from a third pump source, having a wavelength, λ₂, which is longer than wavelength λ₁, is also provided into one of the inputs of the 2×2 coupler. The pump from the third pump source has, for example, the same power as the pumps from each of the first two pump sources. Each of the two outputs of the coupler provides a pump having the wavelength λ₂ and having ½ as much power as that emitted by the third pump source. Alternatively, in order to minimize the number of pump sources in the system, the lower power pumps may be shared by providing a high power signal into the 2×2 coupler. Thus, instead of providing two pumps into the 2×2 coupler, only one pump having a power equal to the sum of powers of the two pumps may instead be provided into the 2×2 coupler. Therefore, an amplifier with a wide dynamic range of pump powers may be obtained by using a P×V coupler, such as a 2×2 coupler, because the pump radiation profile output by the coupler contains a range of pump powers, even when the pump powers input into the coupler are the same.

Of course, the present invention is not limited to the exemplary three pump sources. Any desired number of pump sources may be used, as long as the pumps emitted by one set of the pump sources have the same or an adjacent wavelength, while the pumps emitted by another set of one or more pump sources has lower power(s) than the sum of the powers of the first set of pumps. While the pump power of all pump sources is preferably the same or about the same, the pump power of some or all of the pump sources may be different, if desired.

The ability to provide multiple pumps having groups of wavelengths and powers to a single amplifier removes the restrictions on wavelength spacing imposed by optical combiners. This allows pumps having the same or adjacent (i.e., closely spaced) wavelengths to provide a higher power in a given wavelength band than it is possible to provide with a single pump.

The amplifier provided in the preferred embodiments of the present invention also provides an improved redundancy. First, redundancy is improved by providing at least two pumps which provide the same or adjacent wavelengths into the P×V coupler. Therefore, if one of such pump sources breaks down or is switched off, the particular wavelength emitted by such pump source is not completely eliminated from the pump profile. Instead, the pump profile emitted from the P×V coupler will contain the same or an adjacent wavelength as that emitted by the broken or switched off pump source, but at a lower power.

Second, in one preferred embodiment, the redundancy is improved by providing at least one spare pump source which is capable of emitting pump radiation having the same or adjacent wavelength as any other pump source. Therefore, if a pump source is not operational, i.e., it is turned off or breaks down, then a spare pump source which emits the same or an adjacent wavelength may be turned on to compensate for the loss. In the example of a 2×2 coupler with three pump sources described above, the spare pump source may emit radiation having the same or an adjacent wavelength as that emitted by the third pump source. Thus, the spare pump source may be turned on when it is determined or detected that the third pump source is broken or when the third pump source is intentionally switched off.

### BRIEF DESCRIPTION OF THE DRAWINGS

FIG. 1 is a schematic diagram of a prior art optical transmission system.

FIG. 2 is graph of a prior art pump profile.

FIGS. 3-7 are schematic diagrams of pump profiles being input into and output from a P×V coupler, according to the preferred embodiments of the present invention.

FIG. 8 is a schematic diagram of an optical transmission system according to the preferred embodiments of the present invention.

### DESCRIPTION OF PREFERRED EMBODIMENTS

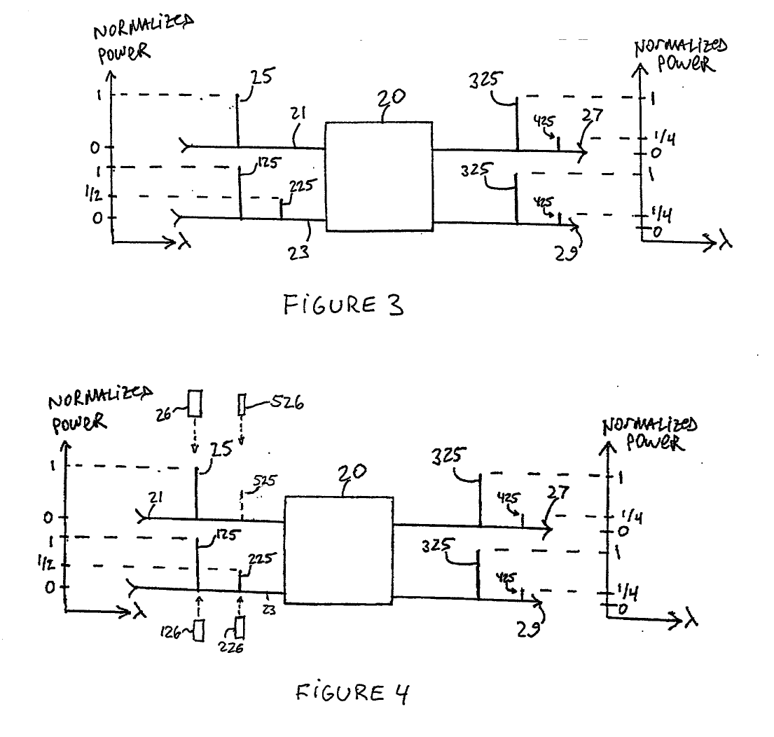

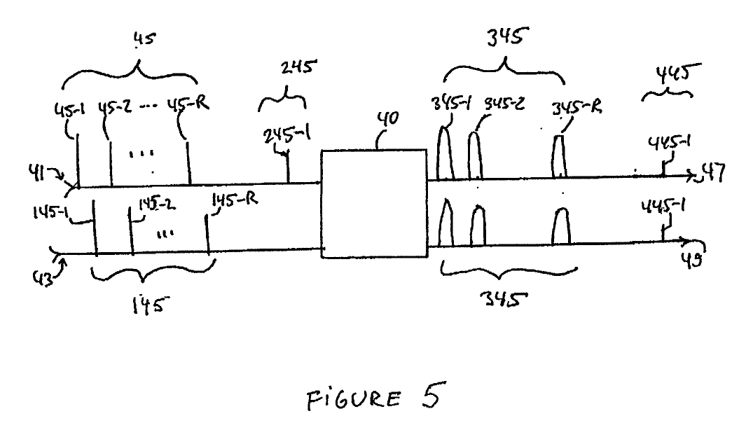

The above described concepts will now be described with respect to a first preferred embodiment of the present invention illustrated in FIG. 3. In the example of FIG. 3, a portion of an amplifier is shown which contains a P×V coupler 20, which comprises a 2×2 coupler (i.e., P=V=2), into which radiation from three pump sources if provided. The 2×2 coupler 20 contains a first input 21, a second input 23, a first output 27 and a second output 29.

A first optical pump having a first wavelength 25 is provided into the first input 21 of the coupler 20 from a first optical pump source. For example, the first optical pump source may be a first semiconductor laser of a group of semiconductor lasers, where the pump radiation emitted by the laser has a narrow wavelength distribution about the first wavelength. The first optical pump having the first wavelength 25 has a first power. For example, the power may range from 40 to 200 mW, preferably from 70 to 140 mW. However, other power may be used, depending on the system requirements. For ease of illustration, a normalized power of 1 unit is illustrated in FIG. 3 for the first optical pump 25.

A second optical pump having a second wavelength 125 is provided into the second input 23 of the coupler 20 from a second optical pump source. For example, the second optical pump may be an emission of a second laser of the group of lasers. The second optical pump preferably has the same power as the power of the first optical pump. However, second optical pump may have a different power than the first optical pump, if desired.

In the example of FIG. 3, the second wavelength 125 is the same as the first wavelength 25. However, if desired the second wavelength 125 may instead be adjacent to the first wavelength 25.

A third optical pump having a third wavelength 225 is provided into either the first input 21 or the second input 23 of the 2×2 coupler 20. In the example of FIG. 3, the third pump is provided into the second input 23. In a preferred aspect of the present invention, adjacent pump wavelengths are wavelengths that are separated by 20 nm or less, most preferably by 10 nm or less.

In one preferred aspect of the present invention, the third optical pump has a power which is less than the sum of the powers of the first and the second signals. Preferably, the third pump has a has a third power which is less than the power of either the first and the second pumps in order to increase the dynamic range of pump powers of the amplifier. For example, as shown in FIG. 3, the power of the third pump is one half of the power of the first and the second pumps. Thus, the normalized power of the third pump is ½. However, if desired, the third optical pump normalized power may be different than ½. For example, the third optical pump power may be the same as, or higher than the power of the first and second pumps. The third wavelength 225 is longer than the first 25 and the second 125 wavelengths. Thus, the third wavelength is preferably neither the same nor adjacent to the first 25 or the second 125 wavelengths.

The 2×2 coupler 20 has two outputs 27 and 29. As discussed above, a special feature of the 2×2 coupler is that each of its two outputs 27 and 29 delivers a radiation profile having every wavelength provided into both of its inputs 21 and 23. However, the magnitude of each radiation profile delivered by each of the outputs 27, 29 has ½ the power of the combined radiation profile provided into its inputs.

Therefore, as illustrated in FIG. 3, each of the outputs 27, 29 contains the same pump radiation profile. That is, the pump radiation profile of each of the outputs 27, 29 contains a fourth optical pump having a fourth wavelength 325 and a fifth optical pump having a fifth wavelength 425. The fourth and fifth pumps may be each considered as sets of one pump.

The fourth pump has the same wavelength 325 as the first 25 and the second 125 pumps. In other words, the coupler 20 combines the first and the second input pumps having the same wavelength, and outputs one fourth pump having the same wavelength 325 as the first and the second pumps. The power of the fourth pump equals to one half of the sum of the powers of the first and the second pumps. If the power of the first and the second pumps is equal, then the power of the fourth pump output by the coupler 20 equals the power of the first and the second pumps. Thus, as shown in FIG. 3, the normalized power of the fourth pump having wavelength 325 signal is 1.

The pump radiation profile of each of the outputs 27, 29 also contains a fifth pump having a fifth wavelength 425. The fifth pump has the same wavelength 425 as the wavelength 225 of the third pump. In the 2×2 coupler 20, the power of the fifth pump equals to one half of the power of the third pump. Thus, as shown in the example of FIG. 3, the normalized power of the fifth pump is ¼ because the normalized power of the third signal is ½. However, even if the normalized power of the third pump was 1, then the normalized power of the fifth pump would be ½, to still provide a dynamic range of pump power.

Thus, as illustrated in FIG. 3, the dynamic range of pump powers of the pump radiation profile of the outputs 27, 29 of the coupler 20 is wider than the dynamic range of pump powers of the inputs 21, 23 of the coupler. While the dynamic range of the pump powers of the pumps input into the coupler 20 in the example of FIG. 3 varies from ½ to 1, the dynamic range of pump powers of the pumps output from the coupler 20 varies from ¼ to 1. Therefore, the use of the 2×2coupler improves the dynamic range of pump powers of the amplifier.

It should be clear that the present invention is not limited to the first preferred embodiment of FIG. 3. FIGS. 4-6 illustrate alternative preferred embodiments of the present invention.

FIG. 4 illustrates a portion of an amplifier according to a second preferred embodiment of the present invention, which contains a spare optical pump source to achieve an improved redundancy. Elements in FIG. 4 having the same number as in FIG. 3 should be presumed to be the same as in FIG. 3.

FIG. 4 also illustrates a portion of an amplifier containing a 2×2 coupler 20. However, the amplifier of this preferred embodiment also contains a spare pump source. For example, as shown in FIG. 4, the first pump having wavelength 25 is emitted by a first pump source 26. The second pump having wavelength 125 is emitted by a second pump source 126. The third pump having wavelength 225 is emitted by a third pump source 226. The amplifier also contains a spare fourth pump source 526. The fourth pump source is adapted to emit a pump having a sixth wavelength 525 (shown as a dashed line in FIG. 4) which is the same as or adjacent to the third wavelength 225. The pump having wavelengths 525 preferably has the same power as the pump emitted by the third pump source. The fourth pump source, which may be a semiconductor laser, is ordinarily switched off during operation of the amplifier (thus wavelengths 525 is shown as a dashed line). However, if the third pump source 226 becomes non-operational, then the fourth pump source 526 is turned on to compensate for the loss of the third pump source. The third pump source 226 may become non-operational because it breaks down, which is detected by a detector in an optical transmission system, or because it is switched off by the system controller. For example, a photodetector and a 2% coupler may be added to a transmission fiber of an optical transmission system to monitor whether one of the pump sources becomes inoperative.

FIG. 5 illustrates a portion of an amplifier according to a third preferred embodiment of the present invention. In the third preferred embodiment, certain wavelengths are adjacent rather than the same. Furthermore, more than three pump sources are used to provide pump radiation. For example, N pumps from N pump sources are input into a 2×2 coupler 40. N may be any integer equal to or greater than 3. In the example of FIG. 5, the N pumps are divided into three arbitrary series of signals, 45, 145 and 245. Each series is provided into a particular input of the coupler. If desired, the amplifier may contain one or more additional spare pump sources for improved redundancy, as described with respect to the second preferred embodiment above.

The first series of signal(s) 45 are provided into the first input 41 of the coupler 40. The second series of signal(s) 145 are provided into the second input 43 of the coupler 40. The third series of signal(s) 245 are provided either into the first 41 or the second input 43 of the coupler 40. Preferably, the wavelengths of the first series 45 of signals are the same as and/or adjacent to the wavelengths of the second series 145. In a preferred aspect of the present invention, adjacent pump wavelengths are wavelengths that are separated by 20 nm or less, most preferably by 10 nm or less.

Each series of pumps may have any desired numbers of signals. For example, as illustrated in FIG. 5, the first 45 and the second 145 series of pumps each have R signals. R may be any integer equal to or greater than 1. Preferably R equals to 4, 5, 6 or 7. However, the first 45 and the second 145 series of pumps may have a different number of signals as desired.

Thus, the first series 45 of pumps contains R signals having wavelengths 45-1, 45-2, . . . 45-R. The second series 145 of pumps has R pumps having wavelengths 145-1, 145-2, . . . 145-R. Each wavelength of the first series 45 of R pumps is either the same as or adjacent to a corresponding wavelength of the second series of R pumps. For example, as illustrated in FIG. 5, the first pump 45-1 of the first series 45 has a wavelength that is adjacent to the first pump 145-1 of the second series 145, and so on up to the R^{th} pump 45-R of the first series which has a wavelength that is adjacent to (or the same as) the R^{th} pump 145-R of the second series.

Preferably the third series 245 of pumps contains only one signal having a wavelength 245-1. However, the third series of pumps may contain more than one signal if desired. The wavelength(s) 245-1 of the pump(s) of the third series is longer than the wavelengths of the pumps of the second or third series. Preferably, the wavelength(s) 245-1 of the pump(s) of the third series 245 is not the same and is not adjacent to any wavelength of the first 45 or the second 145 series. The power of the pump(s) of the third series is lower than the power of the pumps of the first and second series. If one or more spare pump sources are present, then preferably such sources emit pump(s) having the same wavelength and pump power as the pump(s) of the third series.

Two pumps having correspondingly adjacent or same wavelengths from each series comprise a signal group. For example, the signals 45-1 and 145-1 make up a signal group. Of course, three or more adjacent or same wavelengths would also comprise a signal group. Preferably, the power of each pump in a group is the same. However, the power of one signal in a group may be different than the power of another signal in the group. The average power of any signal group may be the same or different as the average power of any other signal group. For example, the power of the shorter wavelength signal group maybe higher than the power of the longer wavelength signal groups.

It should be noted that the spacing between adjacent wavelengths of the input pumps may be the same for all groups of adjacent input pumps or different for each group of adjacent input pumps. There may also be three or more input pumps which have the same or adjacent wavelengths. This arrangement improves the dynamic range of pump powers of the amplifier. Furthermore, if desired, the first 45 and the second 145 series of the input pumps may contain two or more signals having the same wavelength as well as two or more signals having adjacent wavelengths, if desired.

As illustrated in FIG. 5, each of the outputs 47, 49 of the coupler 40 contains the same pump profile. That is, the pump profile of each of the outputs 47, 49 contains a fourth series 345 of R sets of optical pumps 345-1, 345-2, . . . , 345-R and a fifth series 445 of optical pumps. In the example of FIG. 5, each set 345-1 to 345-R contains two pumps having adjacent wavelengths and the fifth series contains only one pump 445-1. Each set of pump wavelengths 345-1, 345-2, . . . 345-R provided by each output of the coupler 40 is due to a particular group of pumps having the same or adjacent wavelengths that are provided into the inputs of the coupler.

The power of each set of pumps having adjacent wavelengths of the fourth series 345 equals to one half of the sum of the powers of the corresponding pumps of the first 45 and the second 145 series. If the power of two adjacent pumps in the first 45 and the second 145 series is equal, then the power of the corresponding set of pump of the fourth series equals the power of the corresponding pumps of the first and the second series. For example, if pumps 45-1 and 145-1 have the same normalized power of 1, then the set of pumps 345-1 also has a normalized power of 1.

The pump radiation profile of each of the outputs 47, 49 of the coupler 40 also contains a fifth series of pumps 445 which results from the third series 245 of the input pumps. The pump(s) of the fifth series 445 have the same wavelength(s) 445-1 as the wavelength 245-1 of the pump(s) of the third series 245. The power of the pump(s) of the fifth series 445 equals to one half of the power of the corresponding pump(s) of the third series 245.

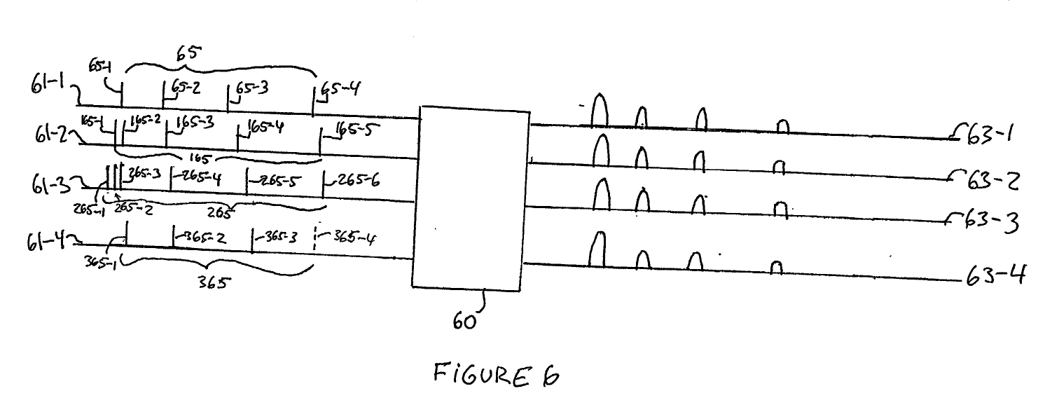

FIG. 6 illustrates an amplifier according to the fourth preferred embodiment of the present invention. In the fourth preferred embodiment, the following features are exemplified. First, a P×V coupler other than a 2×2 coupler may used. For example, a 4×4 coupler is illustrated in FIG. 6. Second, the amplifier may contain more than two sources which emit groups of pumps having the same or adjacent wavelengths. For example, five such signals are illustrated in FIG. 6. Third, the pumps having the same or adjacent wavelengths may be provided into the same input of a coupler rather than to different inputs.

FIG. 6 illustrates a 4×4 coupler 60. The coupler 60 has four inputs 61-1, 61-2, 61-3 and 61-4 and four outputs 63-1, 63-2, 63-3 and 63-4. In the example of FIG. 6, four series of inputs 65, 165, 265, 365 are provided into the inputs of the coupler 60. The first 65, the second 165, the third 265 and the fourth 265 series of pumps contain corresponding pumps having the same or adjacent wavelengths.

For example, the first series 65 contains four pumps having wavelengths 65-1, 65-2, 65-3 and 65-4 that are provided into the first input 61-1 of the coupler 60. The second series 165 contains five pumps having wavelengths 165-1, 165-2, 165-3, 165-4 and 165-5 that are provided into the second input 61-2 of the coupler 60. The third series 165 contains six pumps having wavelengths 265-1, 265-2, 265-3, 265-4, 265-5 and 265-6 that are provided into the third input 61-3 of the coupler 60. The fourth series 365 contains three pumps having wavelengths 365-1, 365-2 and 365-3 that are provided into the fourth input 61-4 of the coupler 60.

The amplifier also contains at least one spare pump source which is ordinarily turned off during operation. However, the spare pump source is turned on when one of the other pump sources becomes non operational. For example, the spare pump source provides the spare pump 365-4 into the input 61-4.

The first group of pumps having the same or adjacent wavelengths comprises wavelengths 65-1, 165-1, 165-2, 265-1, 265-2, 265-3 and 365-1. Thus, more than two pump sources are provided which emit pumps having the same or adjacent wavelengths. Furthermore, the pumps having the same or adjacent wavelengths 165-1, 165-2 and 265-1, 265-2, 265-3 are provided into the same input 61-2 and 61-3, respectively of the coupler 60.

Likewise wavelengths 65-2, 165-3, 265-4, 365-2 are the same or adjacent, wavelengths 65-3, 165-4, 265-5 and 265-3 are the same or adjacent and wavelengths 65-4, 165-5 and 265-6 are the same or adjacent. By providing more pumps having the same or adjacent wavelengths, the dynamic range of pump powers of the amplifier is improved.

As with the amplifiers of the first through the third preferred embodiments, the coupler 60 outputs V pump radiation profiles based on the combination of input pump wavelengths. For example, each output 63-1 to 63-4 contains an identical pump profile, having three or more (i.e., four) sets of pumps. The pump sets at the shorter wavelengths have a higher power than those at longer wavelengths, because more pumps were provided at shorter than longer wavelengths, as shown in FIG. 6. In an alternative preferred aspect of the present invention, less power is provided at launch for the longer wavelength pumps, due to the subsequent pump-pump amplification of the longer wavelengths by the shorter wavelengths. The sets of pumps at the longest wavelength have the lowest power because the spare pump source is turned off during normal operation. Thus, one of the longest wavelength pump 365-4 is not provided into the coupler from the spare pump source during normal operation.

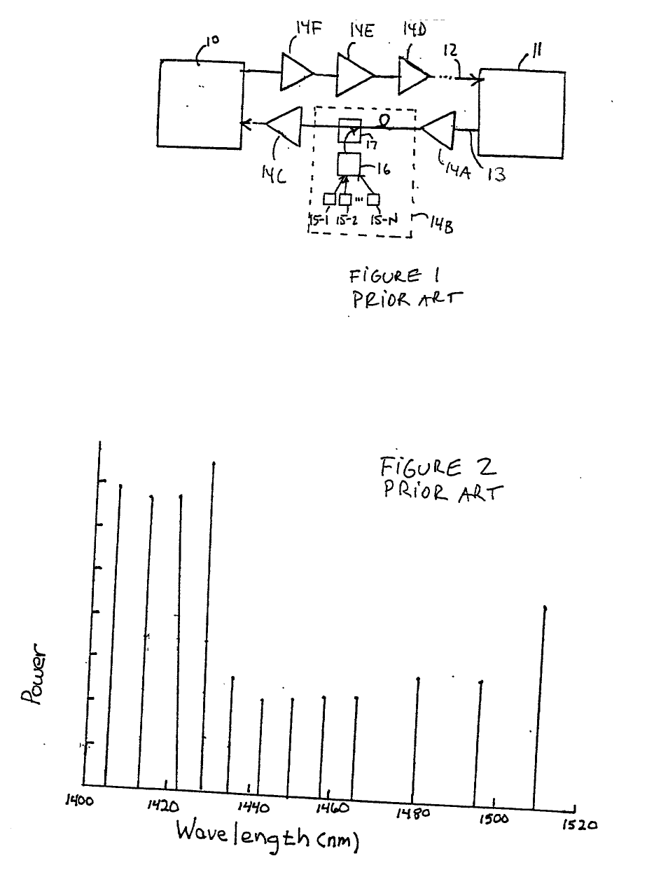

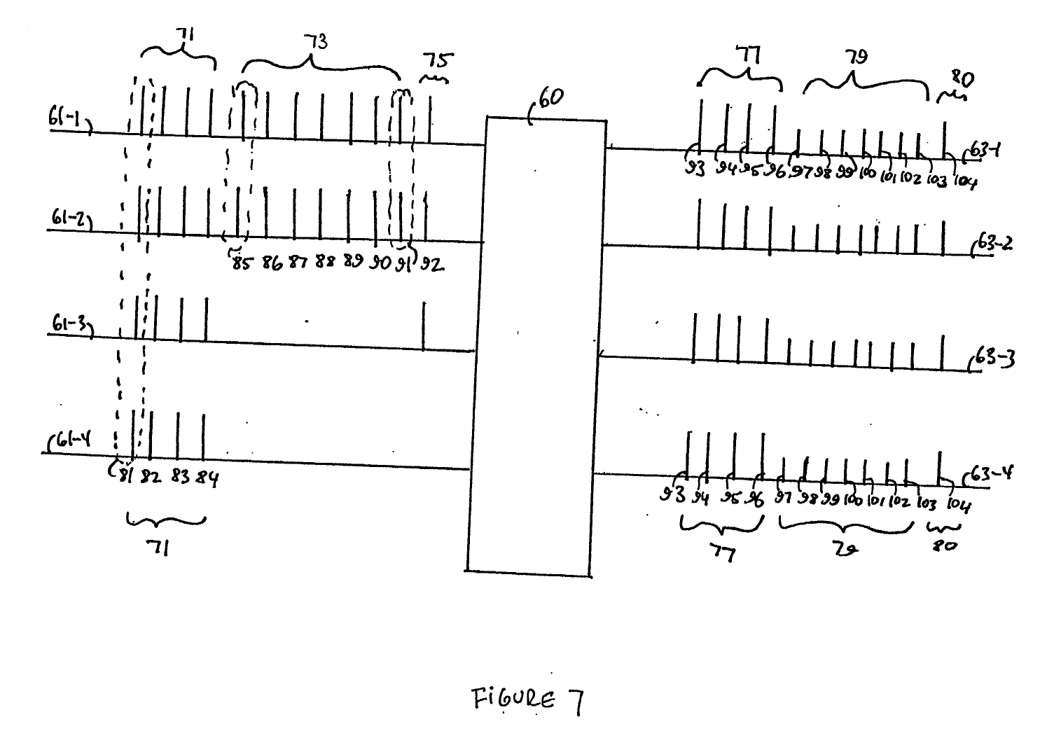

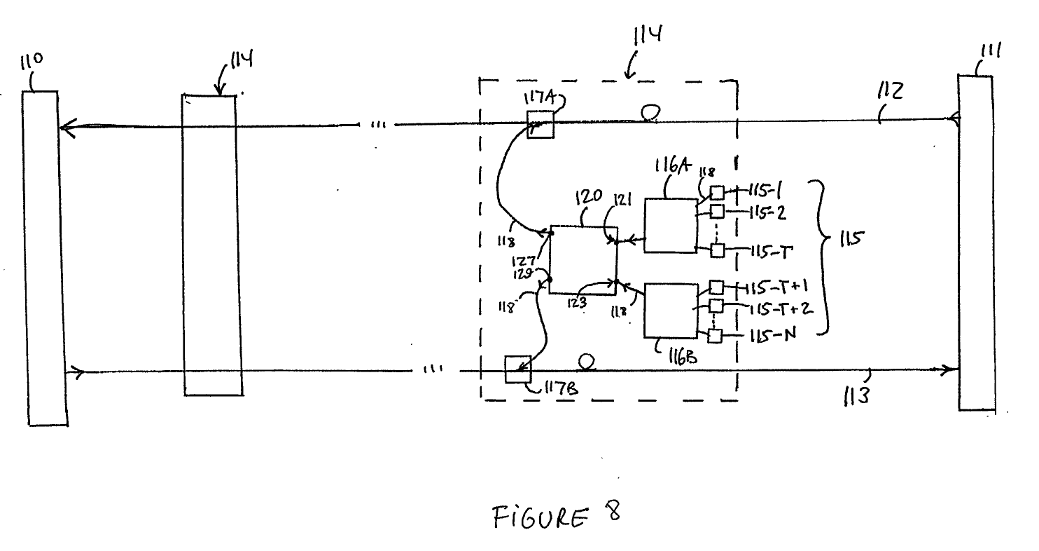

FIG. 7 illustrates a fifth preferred embodiment of the present invention, where the pump profile similar to that of FIG. 2 is achieved by using a 4×4 coupler. For example, twelve pumps having the same power are provided into the first input 61-1 of the 4×4 coupler 60. Another twelve pumps having the same respective wavelengths as the first twelve pumps are provided into the second input 61-2. Five pumps are provided into the third input 61-3. These pumps have the same respective wavelengths as the four shortest and the one longest wavelength pumps provided into the first two inputs of the coupler 60. Four pumps are provided into the fourth input 61-4. These pumps have the same respective wavelengths as the four shortest wavelength pumps provided into the first two inputs of the coupler 60. Thus, a series 71 of short wavelength pumps is provided into all four inputs of the coupler, while series 73, 75 of longer wavelength pumps are provided only into some inputs of the coupler 60. If desired, the amplifier may also contain one or more spare pump sources which are turned off during amplifier operation. These spare pump sources can provide the additional longer wavelength pumps having the same wavelengths as the pumps provided into the into the first and second inputs of the coupler, if any of these pumps become non operational.

Each coupler output 63-1 to 63-4 contains a high power series of pumps 77 at shorter wavelengths and a low power series of pumps 79 at longer wavelengths. The high power series 77 occurs because more pumps are input into the coupler 60 at shorter wavelengths. The low power series 79 occurs because less pumps are input into the coupler 60 at longer wavelengths. An intermediate series 80 occurs because an intermediate number of pumps are input at the highest wavelength. In other words, the shorter wavelength groups of pumps 81-84 contain more pumps (four per group) than the longer wavelength groups 85-91 (two per group). Thus, each set of shorter wavelength pumps 93-96 provided by the coupler 60 outputs has a higher power than each set of longer pumps 97-103 provided by the coupler 60 outputs. Of course, there may be more or less than twelve pumps provided by the coupler outputs. For example, there may be 13-24 sets of such pumps, such as 20 sets of such pumps.

By optimizing the number of coupler inputs, the number of series of pumps, the number of pumps in each series and the power of the pumps in each series, an amplifier with an optimum dynamic range of pump powers may be obtained. In the above described preferred embodiments, the groups of pumps having the same or adjacent wavelengths had shorter wavelengths than the other, unpaired pumps. However, the groups of pumps having the same or adjacent wavelengths may have longer wavelengths than the other pumps in order to obtain a pump profile similar to that shown in FIG. 2, in order to obtain a higher powered pump at a longer wavelength (i.e., such as the pump at 1510 nm in FIG. 2) than at a shorter wavelength (i.e., such as the pump at 1495 nm in FIG. 2).

The amplifiers described above may be any type of optical amplifier that is used in any type of an optical transmission system. Preferably, the amplifier comprises a Raman amplifier. FIG. 8 illustrates an optical transmission system containing at least one Raman amplifier 114 according to a preferred aspect of the present invention that utilizes the P×V coupler of the preferred embodiments.

It should be understood that long distance transmission systems preferably contains a plurality of such Raman amplifiers 114. The optical transmission system includes first and second terminals 110, 111 remotely located from each other. Each terminal 110, 111 is capable of operating as an emitter and/or a receiver terminal. A first 112 and a second 113 optical transmission fibers connect the first 110 and the second 111 terminals. At least one Raman amplifier 114 is coupled to the transmission fibers 112, 113 between the terminals 110 and 111.

Each amplifier 114 contains N pump radiation sources 115 (115-1 to 115-N), such as semiconductor lasers or light emitting diodes. However, the radiation sources may comprise a single source which emits a plurality of wavelengths, such as a semiconductor pump laser and a high power fiber laser. Alternatively, each radiation source 115 may comprise two lasers which emit pumps having the same wavelength, a filter and polarization combiner, which combines orthogonally polarized inputs to a single output. In order to compensate for the pump-pump interactions, each of the sources 115-1 to 115-N preferably has a different emission power to improve gain flatness. However, the emission power of some or all sources may be the same, if desired.

Preferably, for a P×V coupler, the N pump sources are arranged in P sets. For example, for a 2×2 coupler 120, the N pump sources are arranged in two sets, as shown in FIG. 8. Such an amplifier arrangement is advantageous due to the increased redundancy. Since there are plural pump sources 115 which emit pumps having the same or adjacent wavelengths, even if one of the sources fails, the intensity of the particular pump wavelength would be reduced rather than eliminated, as would in the prior art system. Furthermore, the power of one or more first pump source(s) may be increased to compensate for a failure of another pump source which used to emit a pump with the same or adjacent wavelength as the first pump source(s). Thus, the system of FIG. 8 is less affected by the failure of one of the lasers than a prior art system.

The first set of pump sources contains T sources, while the second set of pump sources contains N-T sources, where T is any integer less than N. For example, T may equal to (N−1)/2. If desired one or more additional spare pump radiation sources described with respect to FIG. 4 may also be provided.

The output of the first set of T pump radiation sources (i.e., lasers 115-1, 115-2, . . . , 115-T) are provided into a first pump wavelength coupler 116A. The pump wavelength coupler 116A couples outputs of the T pump radiation sources, and provides the outputs of the T pump sources into a first input 121 of the 2×2 coupler 120. For example, N may preferably equal to 4 to 24. In this case, T may preferably equal to 2 to 12.

The output of the second set of N-T pump radiation sources (i.e., lasers 115-T+1, 115-T+2, . . . , 115-N) are provided into a second pump wavelength coupler 116B. The pump wavelength coupler 116B couples outputs of the N-T pump radiation sources, and provides the outputs of the N-T pump sources into a second input 123 of the 2×2 coupler 120.

As discussed above, the present invention is not limited to an amplifier having a 2×2 coupler. For example, for an amplifier having a 4×4 coupler, there are 4 sets of pump radiation sources and four pump wavelength couplers. Such an amplifier may be used to amplify signals in four transmission fibers.

The 2×2 coupler 120 has two outputs, 127 and 129. The first output 127 of the 2×2 coupler 120 is provided to a first pump-signal combiner 117A. The pump-signal combiner 117A couples the first output 127 of the 2×2 coupler 120 to the first transmission fiber 112. The second output 129 of the 2×2 coupler 120 is provided to a second pump-signal combiner 117B. The pump-signal combiner 117B couples the second output 120 of the 2×2 coupler 120 to the second transmission fiber 113. The pumps are counterpropagating to the data signals in the fibers 112, 113.

The amplifier 114 also contains connecting optical fibers 118 which connect the N pump sources 115 to the first and the second wavelength couplers 116A, 116B. The fibers 118 also connect the first and the second wavelength couplers 116A, 116B to the respective first 121 and second 123 inputs of the 2×2 coupler 120 and connect the first 127 and the second 129 outputs of the 2×2 coupler to the respective first 117A and second 117B pump-signal combiners. Thus, a single set of pump sources 115 may be used to amplify a transmission signal in two transmission fibers 112, 113 by using the 2×2 coupler. In contrast, a separate amplifier has to be used for each transmission fiber of the prior art system of FIG. 1. However, the Raman amplifier 114 may be discrete, where the amplification occurs in an additional spooled gain fiber.

The preferred embodiments have been set forth herein for the purpose of illustration. However, this description should not be deemed to be a limitation on the scope of the invention. Accordingly, various modifications, adaptations, and alternatives may occur to one skilled in the art without departing from the scope of the claimed inventive concept.

1. An optical amplifier having a dynamic range of pump power, comprising:
a plurality of optical pump sources which are adapted to emit a plurality of pumps;
a P×V coupler containing P inputs and V outputs, adapted to receive the plurality of pumps and to output V pump profiles, where P and V are positive integers >1 and P=V or P≠V; and
wherein at least one output pump profile comprises:
a first set of pumps having a first set of wavelengths and having a first power; and
a second set of pumps having a second set of wavelengths different from the first set of wavelengths and having a second power different than the first power.

2. The optical amplifier of claim 1, wherein:
the first set of pumps comprises one pump having a first wavelength and the first power; and
the second set of pumps comprises one pump having a second wavelength longer than the first wavelength and the second power lower than the first power.

3. The optical amplifier of claim 1, wherein:
the first set of pumps comprises at least two pumps having first adjacent wavelengths and having the first power; and
the second set of pumps comprises at least one pump having one, or more than one adjacent second wavelengths longer than the first wavelengths and having the second power lower than the first power.

4. The optical amplifier of claim 1, wherein each of the V output signal profiles are the same.

5. The optical amplifier of claim 4, wherein each of the V output signal profiles contain three or more sets of pumps, each set of pumps having different wavelengths and different powers.

6. The optical amplifier of claim 4, wherein at least a first input pump and a second input pump provided into the P×V coupler have wavelengths that are the same or are adjacent to each other, and at least one third input pump provided into the P×V coupler has a power which is less than a sum of powers of the first and the second input pumps.

7. The optical amplifier of claim 6, wherein:
the third input pump has a wavelength that is longer than the wavelengths of the first and the second input pumps, and this wavelength is neither the same as nor adjacent to the wavelengths of the first and the second input pumps; and
the third pump has a lower power than each of the first and the second input pumps.

8. The optical amplifier of claim 7, wherein the wavelengths of the first and the second input pumps are the same.

9. The optical amplifier of claim 7, wherein the wavelengths of the first and the second input pumps are adjacent and are separated by 20 nm or less.

10. The optical amplifier of claim 9, wherein adjacent wavelengths comprise wavelengths that are separated by 10 nm or less.

11. The optical amplifier of claim 1, further comprising at least one spare optical pump source which is adapted to be turned off during operation of the amplifier unless at least one of the plurality of optical pump sources, which provide the second set of pumps output by the P×V coupler, becomes non operational during the operation of the amplifier.

12. An in-use optical amplifier of claim 11, wherein:
the plurality of optical pump sources are providing the plurality of pumps into the P×V coupler, such that there are more optical pump sources which provide the first set of pumps than the second set of pumps output by the P×V; and
the at least one spare optical pump source is turned off.

13. The optical amplifier of claim 5, wherein the plurality of optical pump sources are adapted to provide a plurality of input pumps into each of the P inputs of the P×V coupler.

14. The optical amplifier of claim 13, wherein the input pumps provided into the P×V coupler contain a plurality of groups of pumps, each group having at least two pumps with the same or adjacent wavelengths.

15. The optical amplifier of claim 14, wherein at least one group contains at least three pumps having the same or adjacent wavelengths.

16. The optical amplifier of claim 14, wherein the P×V coupler comprises a 4×4 coupler.

17. The optical amplifier of claim 16, wherein:
a first group of pumps provided into the P×V coupler results in the first set of pump wavelengths output by the P×V coupler;
a second group of pumps provided into the P×V coupler results in the second set of pump wavelengths output by the P×V coupler; and
the first group contains more pumps than the second group.

18. The optical amplifier of claim 17, wherein a third group of pumps provided into the P×V coupler results in the third set of pump wavelengths output by the P×V coupler.

19. The optical amplifier of claim 13, wherein the optical amplifier comprises a Raman optical amplifier which further comprises:
a first pump wavelength coupler which is arranged to couple outputs of a first set of optical pump sources, and to provide the outputs of the first set of optical pump sources into a first input of the P×V coupler;
a second pump wavelength coupler which is arranged to couple outputs of a second set of optical pump sources, and to provide the outputs of the second set of optical pump sources into a second input of the P×V coupler
a first pump-signal combiner which is adapted to couple a first output of the P×V coupler to a first transmission fiber;
a second pump-signal combiner which is adapted to couple a second output of the P×V coupler to a second transmission fiber; and
connecting optical fibers which connect the plurality of optical pump sources to the first and the second wavelength couplers, which connect the first and the second wavelength couplers to the respective first and second inputs of the P×V coupler, and which connect the first and the second outputs of the P×V coupler to the respective first and second pump-signal combiner.

20. An optical transmission system comprising:
first and second transmitter/receiver terminals remotely located from each other;
first and second optical transmission fibers connecting the first and the second terminals; and
the Raman optical amplifier of claim 19 connected to the first and the second optical transmission fibers.

21. An optical amplifier having a dynamic range of pump power, comprising:
a plurality of optical pump sources which are adapted to emit a plurality of pumps;
a P×V coupler containing P inputs and V outputs, adapted to receive the plurality of pumps and to output V pump profiles, where P and V are positive integers >1 and P=V or P≠V;
wherein at least one output pump profile comprises:
a first set of pumps having a first set of wavelengths and having a first power; and
a second set of pumps having a second set of wavelengths different from the first set of wavelengths and having a second power different than the first power; and
at least one spare optical pump source which is adapted to be turned off during operation of the amplifier unless at least one of the plurality of optical pump sources, which provide the second set of pumps output by the P×V coupler, becomes non operational during the operation of the amplifier.

22. The optical amplifier of claim 21, wherein:
the first set of pumps comprises one pump having a first wavelength and the first power; and
the second set of pumps comprises one pump having a second wavelength longer than the first wavelength and the second power lower than the first power.

23. The optical amplifier of claim 21, wherein:
the first set of pumps comprises at least two pumps having first adjacent wavelengths and having the first power; and
the second set of pumps comprises at least one pump having one, or more than one adjacent second wavelengths longer than the first wavelengths and having the second power lower than the first power.

24. The optical amplifier of claim 21, wherein each of the V output signal profiles are the same.

25. The optical amplifier of claim 24, wherein each of the V output signal profiles contain three or more sets of pumps, each set of pumps having different wavelengths and different powers.

26. The optical amplifier of claim 24, wherein at least a first input pump and a second input pump provided into the P×V coupler have wavelengths that are the same or are adjacent to each other, and at least one third input pump provided into the P×V coupler has a power which is less than a sum of powers of the first and the second input pumps.

27. The optical amplifier of claim 26, wherein:
the third input pump has a wavelength that is longer than the wavelengths of the first and the second input pumps, and this wavelength is neither the same as nor adjacent to the wavelengths of the first and the second input pumps; and
the third pump has a lower power than each of the first and the second input pumps.

28. The optical amplifier of claim 27, wherein the wavelengths of the first and the second input pumps are the same.

29. The optical amplifier of claim 27, wherein the wavelengths of the first and the second input pumps are adjacent and are separated by 20 nm or less.

30. The optical amplifier of claim 29, wherein adjacent wavelengths comprise wavelengths that are separated by 10 nm or less.

31. An in-use optical amplifier of claim 21, wherein:
the plurality of optical pump sources are providing the plurality of pumps into the P×V coupler, such that there are more optical pump sources which provide the first set of pumps than the second set of pumps output by the P×V; and
the at least one spare optical pump source is turned off.

32. The optical amplifier of claim 25, wherein the plurality of optical pump sources are adapted to provide a plurality of input pumps into each of the P inputs of the P×V coupler.

33. The optical amplifier of claim 32, wherein the input pumps provided into the P×V coupler contain a plurality of groups of pumps, each group having at least two pumps with the same or adjacent wavelengths.

34. The optical amplifier of claim 33, wherein at least one group contains at least three pumps having the same or adjacent wavelengths.

35. The optical amplifier of claim 33, wherein the P×V coupler comprises a 4×4 coupler.

36. The optical amplifier of claim 35, wherein:
a first group of pumps provided into the P×V coupler results in the first set of pumps output by the P×V coupler;
a second group of pumps provided into the P×V coupler results in the second set of pumps output by the P×V coupler; and
the first group contains more pumps than the second group.

37. The optical amplifier of claim 36, wherein a third group of pumps provided into the P×V coupler results in the third set of pumps output by the P×V coupler.

38. The optical amplifier of claim 32, wherein the optical amplifier comprises a Raman optical amplifier which further comprises:
a first pump wavelength coupler which is arranged to couple outputs of a first set of optical pump sources, and to provide the outputs of the first set of optical pump sources into a first input of the P×V coupler;
a second pump wavelength coupler which is arranged to couple outputs of a second set of optical pump sources, and to provide the outputs of the second set of optical pump sources into a second input of the P×V coupler;
a first pump-signal combiner which is adapted to couple a first output of the P×V coupler to a first transmission fiber;
a second pump-signal combiner which is adapted to couple a second output of the P×V coupler to a second transmission fiber; and
connecting optical fibers which connect the plurality of optical pump sources to the first and the second wavelength couplers, which connect the first and the second wavelength couplers to the respective first and second inputs of the P×V coupler, and which connect the first and the second outputs of the P×V coupler to the respective first and second pump-signal combiner.

39. An optical transmission system comprising:
first and second transmitter/receiver terminals remotely located from each other;
first and second optical transmission fibers connecting the first and the second terminals; and
the Raman optical amplifier of claim 38 connected to the first and the second optical transmission fibers.

40. The optical transmission system of claim 39, further comprising a detector which detects when an optical pump source becomes non operational.

41. A method of transmitting optical signals, comprising:
providing an optical data signal into a first transmission fiber;
providing a plurality of input pumps into a P×V coupler containing P inputs and V outputs, where P and V are positive integers >1 and where P=V or P≠V;
providing a first output pump profile from a first output of the P×V coupler into the first transmission fiber to amplify the optical data signal;
wherein the first output pump profile comprises:
a first set of pumps having a first set of wavelengths and having a first power; and
a second set of pumps having a second set of wavelengths different from the first set of wavelengths and having a second power different than the first power.

42. The method of claim 41, wherein:
the first set of pumps comprises one pump having a first wavelength and the first power; and
the second set of pumps comprises one pump having a second wavelength longer than the first wavelength and the second power lower than the first power.

43. The method of claim 41, wherein:
the first set of pumps comprises at least two pumps having first adjacent wavelengths and having the first power; and
the second set of pumps comprises at least one pump having one, or more than one adjacent second wavelengths longer than the first wavelengths and having the second power lower than the first power.

44. The method of claim 41, further comprising:
providing an identical output pump profile from each output of the P×V coupler into a plurality of transmission fibers;
wherein each output signal profile comprises:
the first set of pumps having the first set of wavelengths and having the first power; and
the second set of pumps having the second set of wavelengths different from the first set of wavelengths and having the second power different than the first power.

45. The method of claim 44, wherein each pump output signal profile contains three or more sets of pumps, each set of pumps having different wavelengths and different powers.

46. The method of claim 44, further comprising:
providing at least a first input pump and a second input pump into the P×V coupler having wavelengths that are the same or are adjacent to each other; and
providing at least one third input pump into the P×V coupler having a power which is less than a sum of powers of the first and the second input pumps.

47. The method of claim 46, wherein:
the third input pump has a wavelength that is longer than the wavelengths of the first and the second input pumps, and this wavelength is neither the same as nor adjacent to the wavelengths of the first and the second input pumps; and
the third pump has a lower power than each of the first and the second input pumps.

48. The method of claim 47, wherein the wavelengths of the first and the second input pumps are the same.

49. The method of claim 47, wherein the wavelengths of the first and the second input pumps are adjacent and are separated by 20 nm or less.

50. The method of claim 49, wherein adjacent wavelengths comprise wavelengths that are separated by 10 nm or less.

51. The method of claim 41, further comprising turning on at least one spare optical pump source which is adapted to be turned off during operation of the amplifier when at least one of a plurality of optical pump sources, which provide the second set of pumps output by the P×V coupler, becomes non operational.

52. The method of claim 51, further comprising detecting when at least one of a plurality of optical pump sources, which provide the second set of pumps output by the P×V coupler, becomes non operational prior to turning on the at least one spare optical pump source.

53. The method of claim 46, further comprising providing a plurality of input pumps into each of the P inputs of the P×V coupler.

54. The method of claim 53, wherein the input pumps provided into the P×V coupler contain a plurality of groups of pumps, each group having at least two pumps with the same or adjacent wavelengths.

55. The method of claim 54, wherein at least one group contains at least three pumps having the same or adjacent wavelengths.

56. The method of claim 54, wherein the P×V coupler comprises a 4×4 coupler.

57. The method of claim 56, wherein:
a first group of pumps provided into the P×V coupler results in the first set of pump wavelengths output by the P×V coupler;
a second group of pumps provided into the P×V coupler results in the second set of pump wavelengths output by the P×V coupler; and
the first group contains more pumps than the second group.

58. The method of claim 57, wherein a third group of pumps provided into the P×V coupler results in the third set of pump wavelengths output by the P×V coupler.

59. The method of claim 41, further comprising:
providing optical data signals into a plurality of transmission fibers; and
providing the pumps from the outputs of the P×V coupler into the plurality of transmission fibers to amplify the optical data signals.

60. A method of transmitting optical signals, comprising:
providing an optical data signal into a first transmission fiber;
providing a plurality of input pumps into a P×V coupler containing P inputs and V outputs, where P and V are positive integers >1 and where P=V or P≠V;
providing a first output pump profile from a first output of the P×V coupler into the first transmission fiber to amplify the optical data signal;
wherein the first output pump profile comprises:
a first set of pumps having a first set of wavelengths and having a first power; and
a second set of pumps having a second set of wavelengths different from the first set of wavelengths and having a second power different than the first power; and
turning on at least one spare optical pump source which is adapted to be turned off during operation of the amplifier when at least one of a plurality of optical pump sources, which provide the second set of pumps output by the P×V coupler, becomes non operational.
